(19) United States
(12) Patent Application Publication
(10) Pub. No.: US 2025/0154670 A1
(43) Pub. Date: May 15, 2025

(54) SEALED ELECTROLYSIS CELL

(71) Applicant: thyssenkrupp nucera AG & Co. KGaA, Dortmund (DE)

(72) Inventors: Emre AYRAK, Essen (DE); Peter TOROS, Essen (DE); Stefan KLINK, Bochum (DE); Jonas BRINKMANN, Bochum (DE)

(73) Assignee: thyssenkrupp nucera AG & Co. KGaA, Dortmund (DE)

(21) Appl. No.: 18/723,023

(22) PCT Filed: Dec. 21, 2022
(86) PCT No.: PCT/EP2022/087203

§ 371 Date: Jun. 21, 2024

(30) Foreign Application Priority Data
Dec. 23, 2021 (EP) 21217263.9

(51) Int. Cl. C25B 9/77; C25B 9/19; C25B 9/63; C25B 13/02

(52) U.S. Cl. CPC C25B 9/77; C25B 9/19; C25B 9/63; C25B 13/02

(57) ABSTRACT

An electrolysis cell comprises two elements, each comprising a central portion defining an anode chamber and a cathode chamber, respectively, and a circumferential flange portion, a sheet-like separator with a circumferential edge, the separator being disposed between the two elements and separating the anode and cathode chambers, and a sealing arrangement comprising at least a first and a second gasket, wherein the sealing arrangement is disposed in a gap between the flange portions, wherein the first gasket is an inner gasket positioned in a portion of the gap adjacent to the chambers and the second gasket is an outer gasket positioned in a portion of the gap distant to the chambers, wherein the gaskets are spaced apart from each other in the gap at an interval, and wherein the circumferential edge of the separator is located radially between a midpoint of the first gasket and a midpoint of the second gasket.

### BACKGROUND OF THE INVENTION

The invention relates to a sealed electrolysis cell according to the preamble of claim 1.

Bipolar electrolyzers for large-scale production of hydrogen and/or chlorine (i.e. in the mega-watt range) can be classified in two major design categories, namely single element design and filter-press design.

In an electrolysis cell of the single element design, the electrolysis cell is a separately sealed unit. Each electrolysis cell comprises two elements forming half-shells with a pan-shaped central portion and circumferential flange portion. The two half-shells are bolted together at their flange portions, with a separator, gaskets and an isolation layer interposed in-between. The sealing force for sealing the electrolysis cell is provided by the plurality bolts distributed circumferentially along the flange portions of the elements. The separator extends through the sealing arrangement to the outside of the cell and is clamped by overlapping gaskets from both sides. An example of this type of electrolysis cell is known e.g. from DE 10 2004 028 761 A1.

In a filter-press electrolyzer, a stack of electrolysis cells is formed in a cell rack by stacking a plurality of elements under interposition of sheet-like separators and gaskets between adjacent elements and compressing the complete stack in order to seal all electrolysis cells at once. In electrolyzers of filter-press design, each element delimits the anode chamber of one electrolysis cell and the cathode chamber of a neighboring electrolysis cell in the stack by a bipolar wall. The sealing force for all cells is provided by tie-rods extending along the stack. The sealing arrangement with the separator extending to the outside of the cell and being clamped by overlapping gaskets from both sides is similar to the single element design. An example of this type of electrolysis cell is known from JP 2012-193437 A.

In both types of electrolysis cells, either ion-exchange membranes or porous diaphragms are used as separators, depending on the intended use of the cell. For example, in chlor-alkali electrolysis membranes are used as separators, because the anode and the cathode chambers are filled with different types of electrolyte, namely brine and caustic, and mixing of these electrolytes is to be prevented by the membrane. Porous diaphragms, instead, are preferred for example in alkaline water electrolysis. In both cases, separators extending to the outside of the sealing arrangement are a potential risk for leakages of electrolyte to the outside of the cell, for example due to inaccuracies during assembly. In particular, in case of porous diaphragms the risk is increased by the capillary effect of the pores, by which the electrolyte can exit from the cell inside to the outside, caused by narrow spaces based on the internal structure of the diaphragm. The capillary effects cannot be stopped, independent of the applied forces. Rather it is a matter of time when the first leakage appears.

EP 3 608 445 A1 addresses the above-mentioned disadvantage of the conventional sealing arrangements and provides an alkaline water electrolyzer, wherein the porous diaphragm is held between the anode chamber frame and the cathode chamber frame via an anode gasket and a cathode gasket, wherein the anode gasket and the cathode gasket are in contact with each other around a peripheral edge of the porous diaphragm by compressing the anode and the cathode gasket. In order to secure the porous diaphragm within the cell and at the same time to safely prevent leakage from the cell, EP 3 608 445 A1 teaches to have at least a width of 3 mm each, for the contact width between the diaphragm and the gaskets and for the width of the direct contact of the gaskets. To fulfill these two tasks at the same time, the separator has to be manufactured and positioned within tight tolerances or gaskets of high width have to be used, requiring higher compression forces in order to provide a specified sealing surface pressure.

### BRIEF SUMMARY OF INVENTION

The object of the invention is to provide an electrolysis cell with a sealing arrangement that is easy to assemble and safely prevents leakage from the cell.

This object is achieved by an electrolysis cell according to the features of claim 1.

Hereby, an electrolysis cell is provided comprising two elements, each of which comprising a central portion delimiting an anode chamber and a cathode chamber, respectively, and a circumferential flange portion. The electrolysis cell further comprises an anode accommodated in the anode chamber, a cathode accommodated in the cathode chamber, and a sheet-like separator with a circumferential edge. The separator is disposed between the two elements and separates the anode and cathode chambers. Further, the electrolysis cell comprises a sealing arrangement with at least a first gasket and a second gasket, wherein the sealing arrangement is disposed in a gap between the flange portions of the elements for fastening the separator and for sealing the anode chamber and the cathode chamber. According to the invention, the first gasket is an inner gasket positioned in a portion of the gap adjacent to the chambers and the second gasket is an outer gasket positioned in a portion of the gap distant to the chambers. The gaskets are spaced apart from each other in the gap at an interval, and the separator is fastened in the cell by means of the first gasket. The circumferential edge of the separator is located radially between a midpoint of the first gasket and a midpoint of the second gasket.

The interval between the gaskets is delimited by an outer edge of the inner, first gasket and an inner edge of the outer, second gasket. The interval in the sense of this disclosure is to be understood as a closed interval, i.e. including its endpoints.

The sealing arrangement according to the invention has the advantage that the two functions of the gaskets, namely to fix the separator inside the electrolysis cell to avoid internal leakages between the chambers and to prevent leakages to the outside, are separately fulfilled by one gasket each. By the offset arrangement of the first and second gasket and positioning the separator edge in the space between the midpoints of the two gaskets, it is achieved that the separator has no direct contact to the outside of the cell. The gap between the flange portions of the elements in rather closed completely to the outside by at least half of the width of the outer gasket. The inner gasket fixes the separator in the electrolysis cell and prevents leakage, in particular gas leakages, between the anode and the cathode chambers.

The interval between the two gaskets further has the advantageous effect that it provides for an additional manufacturing tolerance for the separator cutting as well as a tolerance for the separator positioning during assembly of the cell. With the separator edge to be positioned between the midpoints of the two gaskets, the tolerance for the separator corresponds to the sum of the interval and the average width of the two gaskets. Thus, the manufacturing of the cell is simplified.

Preferably, the edge of the separator is located in the interval between the first gasket and the second gasket. Thus, the edge of the separator may either lie between the outer edge of the first gasket and the inner edge of the second gasket or be flush with either of these edges. In these embodiments, the complete width of the first gasket is utilized to fasten the separator in the cell and the complete width of the second gasket is utilized for outer cell sealing, resulting in a particularly safe sealing of the cell. Further, the outer gasket can be used as a form-fitting positioning aid for the separator during assembly of the cell.

In preferred embodiments, the separator is a porous diaphragm. The inventive sealing arrangement is particularly useful in combination with porous diaphragms, as leakages due to the capillary effects are particularly difficult to prevent in the conventional sealing arrangements. Since the capillary effects of the porous structure only reach up to the edge of the separator, which is safely sealed to the outside by the second gasket, capillary effects cannot sidestep the sealing arrangement according to the invention.

Preferably, the sealing arrangement comprises exactly two gaskets. Two gaskets are sufficient to provide one gasket for each function, i.e. inner and outer sealing of the cell. Dispensing of any additional gaskets simplifies assembly and reduces material costs. In preferred embodiments, the sealing arrangement further comprises an electrically isolating layer, which is disposed in the gap such that a first side of the layer is in contact with the first gasket and a second, opposite side of the layer is in contact with the second gasket. The isolating layer provides for an electrical isolation between the elements. By arranging the gaskets on opposite sides of the isolating layer a particularly good sealing performance is achieved, since each flange portion is in direct contact with one of the gaskets.

The width of the interval between the gaskets is subject to a trade-off between easy manufacture due to large tolerances at high interval widths and large space requirements coming with high interval width. For practical reasons, the interval is preferably chosen in the range of 1 mm to 20 mm, more preferably between 2 mm and 10 mm. In particular, the interval is preferably in the range of 0.5 to 1.5 times the smallest width of the gaskets.

Preferably, gaskets are compressed within the gap by means of a screwed connection of the flange portions. In particular it is preferred, that the screwed connection comprises at least two beams compressing the flange portions from both sides and bolts connecting the beams, which bolts are positioned on the outer side of the second gasket. In such an arrangement, the bolts do not compromise the sealing effect of the gaskets, as they are positioned on the outer side of both gasket. The beams are used transfer the force applied by the bolts radially inwards to the first and second as to provide the required sealing surface pressure.

In preferred embodiments, the central portions are pan-shaped half-shells and the electrolysis cell is of single element design. In alternative embodiments, the central portions form a bipolar wall and the flange portions are provided by a solid frame, such that the elements are configured to be stacked according to the filter-press design.

The elements are preferably made of a metal, particularly preferably of nickel and/or titanium. In particular, the invention relates to electrolysis cells of industrial scale to be used for chlor-alkali or alkaline water electrolysis. The separator of the electrolysis cell according to the invention therefore preferably has an area of 1 m² to 5 m². Further, the electrolysis cell is preferably configured for current densities of at least 3 kA/m².

Further advantages of the invention are described in the following with regard to the embodiments shown in the attached drawings.

### BRIEF DESCRIPTION OF DRAWINGS

FIG. 1 shows schematically in a cross-sectional partly exploded view a first embodiment of the inventive electrolysis cell of single element design,

FIG. 2 show schematically in a cross-sectional partly exploded view a second embodiment of the inventive electrolysis cell of filter-press design.

### DETAILED DESCRIPTION OF INVENTION

In the drawings same parts are consistently identified by the same reference signs and are therefore generally described and referred to only once.

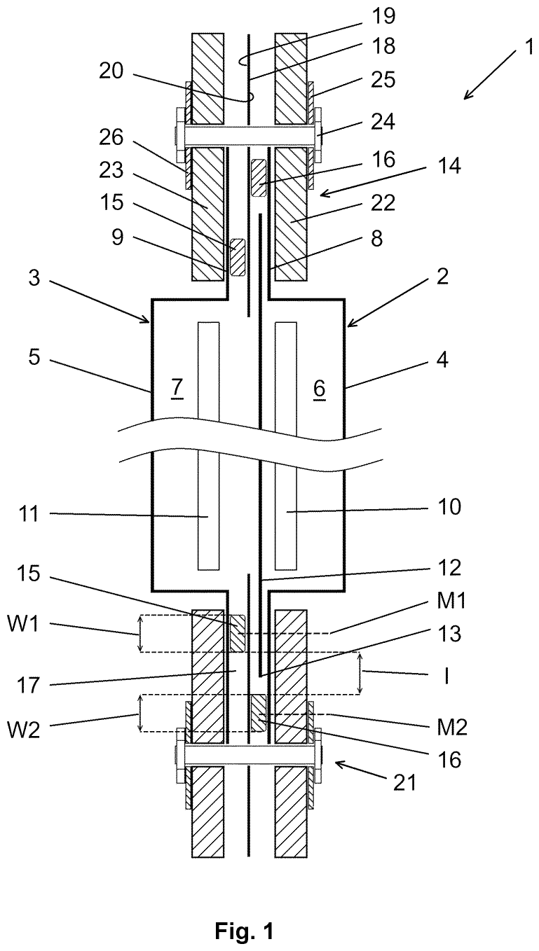

In FIG. 1, a first embodiment of the inventive electrolysis cell 1 is shown in a partly exploded state.

The electrolysis cell 1 comprises two elements 2, 3. Each element 2, 3 includes a central portion 4, 5 delimiting an anode chamber 6 and a cathode chamber 7, respectively, and a circumferential flange portion 8, 9. In the anode chamber 6 an anode 10 is accommodated and in the cathode chamber 7 a cathode 11 is accommodated.

Further, the anode and cathode chamber 6, 7 contain elements for supporting the electrodes 10, 11 and for current distribution, as well as components to distribute electrolyte within the cell 1 and to discharge used electrolyte and electrolysis products from the cell 1. These elements are not shown in FIG. 1 for simplicity.

The electrolysis cell 1 further comprises a sheet-like separator 12 with a circumferential edge 13. The separator 12 is disposed between the two elements 2, 3 and separates the anode and cathode chambers 6, 7. In addition, the electrolysis cell 1 comprises a sealing arrangement 14 with a first gasket 15 and a second gasket 16. The sealing arrangement 14 is disposed in a gap 17 between the flange portions 8, 9 of the elements 2, 3 for fastening the separator 12 and for sealing the anode chamber 6 and the cathode chamber 7.

The first gasket 15 is an inner gasket positioned in a portion of the gap 17 adjacent to the chambers 6, 7 and the second gasket 16 is an outer gasket positioned in a portion of the gap 17 distant to the chambers 6, 7. The gaskets 15, 16 are spaced apart from each other in the gap 17 at an interval I. The separator 12 it fastened in the cell 1 by means of the first gasket 15. The circumferential edge 13 of the separator 12 is located radially between a midpoint M1 of the first gasket 15 and a midpoint M2 of the second gasket 16. The midpoints M1, M2 are midpoints with respect to the width direction of the gaskets 15, 16, i.e. in the radial direction of the cell 1.

In the embodiment shown in FIG. 1 the edge 13 of the separator 12 is located in the interval I between the first gasket 15 and the second gasket 16. The interval I is preferably in the range of 1 mm to 20 mm, more preferably between 2 mm and 10 mm.

The gaskets 15, 16 may be, for example, frame-shaped rubber sheets. The gasket 15, 16 are required to have resistance to, for example, corrosive electrolytes and generated gases, and also required to be workable for a long term. In view of chemical resistance and hardness, therefore, the gaskets 15, 16 are preferably made of, for example, vulcanized or peroxide-crosslinked ethylene-propylene-diene rubber (EPDM) or ethylene-propylene rubber (EPM). If necessary, the gasket to be used may also be covered with fluororesin such as polytetrafluoroethylene (PTFE) or tetrafluoroethylene-perfluoroalkyl vinyl ether copolymer (PFA) at least at its region to be in contact with liquids.

The separator 12 is preferably a porous diaphragm. Particularly preferably, the porous diaphragm may be a diaphragm for alkaline water electrolysis. Such a diaphragm for alkaline water electrolysis typically includes a sheet-shaped porous support and an organic polymer resin with which the support is impregnated. The support may be a nonwoven fabric, a woven fabric, or a composite of nonwoven and woven fabrics. The support is preferably made of fibers of at least one selected from the group consisting of polyphenylene sulfide, polypropylene, polysulfone, polyether sulfone, polyphenyl sulfone, fluororesin, polyketone, polyimide, and polyether imide. The organic polymer resin preferably includes at least one selected from the group consisting of polysulfone, polyether sulfone, polyphenyl sulfone, polyvinylidene fluoride, polycarbonate, polytetrafluoroethylene, polypropylene, polyphenylene sulfide, polyketone, polyether ether ketone, polyimide, and polyether imide.

Alternatively, the separator 12 may be an ion-exchange membrane.

The sealing arrangement 14 further comprises an electrically isolating layer 18, which is disposed in the gap 17 such that a first side 19 of the layer 18 is in contact with the first gasket 15 and a second, opposite side 20 of the layer 18 is in contact with the second gasket 16.

The interval I is preferably in the range of 0.5 to 1.5 times the smallest width W1, W2 of the gaskets 15, 16. The smallest width W1, W2 is to be measured in an uncompressed state of the gaskets. The gaskets 15, 16 preferably have a width in the range of 4 mm to 10 mm and a height in the range of 1 mm to 4 mm in the uncompressed state.

The central portions 4, 5 of the elements 2, 3 in FIG. 1 are pan-shaped half-shells and the electrolysis cell 1 is of single element design. The gaskets 15, 16 are compressed within the gap by means of a screwed connection 21 of the flange portions 8, 9. The screwed connection 21 comprises at least two beams 22, 23 compressing the flange portions 8, 9 from both sides and bolts 24 connecting the beams 22, 23 in a tightened state of the bolts 24. The bolts 24 are positioned on the outer side of the second gasket 16. In order to transfer and distribute the bolt forces to the beams 22, 23, washers 25, 26 are preferably provided.

As compared to the partly exploded state shown FIG. 1, in an operative state of the cell 1, the bolts 24 are fastened, such that the gaskets 15, 16 are compressed in the gap 17 and the separator 12 as well as the isolating layer 18 are clamped between the flange portions 8, 9.

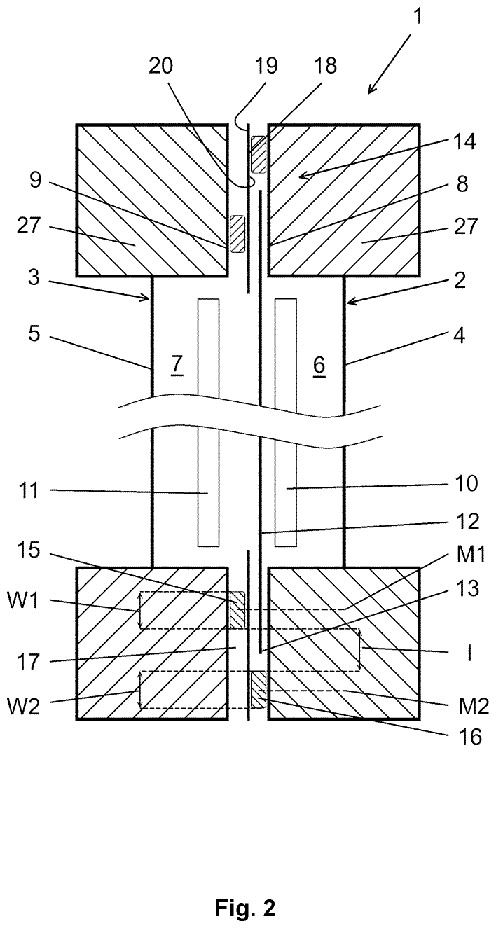

FIG. 2 shows a second embodiment of the electrolysis cell 1 according to the invention. The electrolysis cell 1 shown in FIG. 2 differs from the first embodiment in that the central portions 4, 5 of the elements 2, 3 form a bipolar wall and the flange portions 8, 9 are provided by a solid frame 27. The elements 2, 3 are thus configured to be stacked according to the filterpress design. In the filter-press design, the sealing force for all electrolysis cells 1 of the stack is provided by tie-rods extending along the stack.

In all other respects, the description of the first embodiment shown in FIG. 1 is applicable to the second embodiment shown in FIG. 2, accordingly.

### LIST OF REFERENCE SIGNS

1 electrolysis cell
2, 3 element
4, 5 central portion
6 anode chamber
7 cathode chamber
8,9 circumferential flange portion
10 anode
11 cathode
12 separator
13 edge of separator
14 sealing arrangement
15 first gasket
16 second gasket
17 gap
18 isolating layer
19 first side of isolating layer
20 second side of isolating layer
21 screwed connection
22, 23 frame
24 bolts
25, 26 washer
I Interval
W1 Width of first gasket
W2 Width of second gasket
M1 Midpoint of first gasket
M2 Midpoint of second gasket

1-11. (canceled)

12. An electrolysis cell, comprising:
a first element including a first circumferential flange portion and a first central portion delimiting an anode chamber;
a second element including a second circumferential flange portion and a second central portion delimiting a cathode chamber;
an anode accommodated in the anode chamber;
a cathode accommodated in the cathode chamber;
a sheet-like separator having a circumferential edge, the separator disposed between the first and second elements and separating the anode and cathode chambers; and
a sealing arrangement including a first gasket and a second gasket, wherein the sealing arrangement is disposed in a gap between the first and second circumferential flange portions for fastening the separator and for sealing the anode chamber and the cathode chamber;
wherein the first gasket is an inner gasket positioned in a portion of the gap adjacent to the chambers and the second gasket is an outer gasket positioned in a portion of the gap distant to the chambers;
wherein the gaskets are spaced apart from each other in the gap at an interval and the separator is fastened in the cell by the first gasket, and wherein the circumferential edge of the separator is located radially between a midpoint of the first gasket and a midpoint of the second gasket;
wherein the sealing arrangement further includes an electrically isolating layer disposed in the gap such that a first side of the layer is in contact with the first gasket and a second, opposite side of the layer is in contact with the second gasket.

13. The electrolysis cell according to claim 12, wherein the edge of the separator is located in the interval between the first gasket and the second gasket.

14. The electrolysis cell according to claim 12, wherein the separator is a porous diaphragm.

15. The electrolysis cell according to claim 12, wherein the sealing arrangement includes exactly two gaskets.

16. The electrolysis cell according to claim 12, wherein the interval is in the range of 1 mm to 20 mm.

17. The electrolysis cell according to claim 12, wherein the interval is in the range of 0.5 to 1.5 times the smallest width of the gaskets.

18. The electrolysis cell according to claim 12, wherein the gaskets are compressed within the gap by a screwed connection of the flange portions.

19. The electrolysis cell according to claim 18, wherein the screwed connection includes at least two beams compressing the flange portions from both sides and bolts connecting the beams, which bolts are positioned on the outer side of the second gasket.

20. The electrolysis cell according to claim 12, wherein the central portions are pan-shaped half-shells and the electrolysis cell is of single element design.

21. The electrolysis cell according to claim 12, wherein the central portions form a bipolar wall and flange portions are provided by a solid frame, such that the elements are configured to be stacked according to a filter-press design.
